(19) United States
(12) Patent Application Publication
(10) Pub. No.: US 2013/0050085 A1
(43) Pub. Date: Feb. 28, 2013

(54) MOUSE BUTTON STRUCTURE

(71) Applicant: Chin-Wen CHOU, New Taipei City (TW)

(72) Inventor: Chin-Wen CHOU, New Taipei City (TW)

(21) Appl. No.: 13/594,688

(22) Filed: Aug. 24, 2012

(30) Foreign Application Priority Data
Aug. 26, 2011 (TW) 100130615

(51) Int. Cl. G06F 3/033

(52) U.S. Cl. 345/163

(57) ABSTRACT

A button structure of a mouse is provided. The mouse includes a lower housing, an upper housing, and a circuit unit disposed between the upper housing and the lower housing. The circuit unit includes at least one press switch, and the upper housing includes at least one button unit. The mouse is characterized in that, the button unit includes a revealed button cap section, a press section connected to the button cap section and extending towards the press switch, and a wear-resisting element attached to the press section. When the button cap section is pressed to move downwards jointly with the press section, the wear-resisting element abuts against the press switch.

### FIELD OF THE INVENTION

The present invention relates to a mouse button structure, particularly to a mouse having a wear-resisting element that abuts against a press switch.

### BACKGROUND OF THE INVENTION

With the prevalence of computers, mouse structures also continuously improve to provide more diversified functions. For example, a mouse is additionally provided with a roller and several extra control buttons. R.O.C Patent No. M299891 discloses a conventional mouse structure. The conventional mouse structure includes a main housing, a base, a circuit board, a button set and a cover. The circuit board is provided with a press switch. The button set is disposed above the main housing, and is a formed integral including two press bodies corresponding to the press switch. One end of the two press bodies is connected to a connecting portion including a positioning column. The main housing further includes a positioning hole for accommodating the positioning column, and a through hole for allowing the press bodies and the roller to pass through. It is observed from the above prior art that, a common mouse includes press bodies, and a position of the press switch on the circuit board exactly corresponds with the press bodies, such that the press switch is triggered through the press bodies when the button set is pressed by a user.

Similarly, “Mouse Button Cover and Mouse Having the Same” disclosed by R.O.C Patent No. M386544 has a structure similar to the above structure. In the prior art disclosed by R.O.C Patent No. M386544, a mouse structure includes a mouse and a base. The base is provided with a printed circuit board having two press switches. The mouse further includes a button cover, and a protruding section is respectively provided at lower sides of left and right buttons of a main body of the button cover. The button cover is disposed on the base, and positions of the two protruding sections respectively correspond to the press switches.

It is seen from the aforementioned two conventional solutions that, a common mouse structure is provided with a press structure for abutting against a press switch on a printed circuit board. A similar structure is also disclosed in R.O.C Patents No. M394528, M319473, M241751 and 1230891.

All of the above conventional solutions include a press body below a button, and a press switch is pressed downwards and abutted by the press body. However, to maintain a simple manufacturing process, the press body is a formed integral with the button through a plastic injection molding process. The buttons, being made of plastic, are given satisfactory physical properties in short-term use. Yet, as time of use prolongs, or being used in extraordinary circumstances of high or low temperatures, the press body may quickly become worn out to lead to difficulties in using the mouse structure.

### SUMMARY OF THE INVENTION

As previously described, in a common mouse structure, a press body is usually a formed integral with a button through a plastic injection molding process, such that the mouse may be excessively worn and thus become difficult to use in a long-run due to a wear-prone property of the material of the press body. Therefore the primary object of the present invention is to overcome such drawback of a conventional mouse press body that is prone to wear in prolonged use.

A button structure of a mouse is provided by the present invention. The mouse includes a lower housing, an upper housing, and a circuit unit disposed between the upper housing and the lower housing. The circuit unit includes at least one press witch, and the upper housing includes at least one button unit. The mouse is characterized in that, the button unit includes a revealed button cap section, a press section connected with the button cap section and extending towards the press section, and a wear-resisting element attached to the press section. When the button cap section is pressed to move downwards jointly with the press section, the wear-resisting element abuts against the press switch.

More specifically, the wear-resisting element is a metal block. Further, for example, the metal block forming the wear-resisting element is a copper compound, an aluminum compound, or an iron compound. Alternatively, the wear-resisting element is a non-metal block. For example, the non-metal block forming the wear-resisting element is carbon fiber, ceramic or a high polymer material. The high polymer material may be polyoxymethylene (POM), i.e., so-called plastic steel. The circuit unit includes a circuit board, and the press switch is electrically connected to the circuit board.

With the technical characteristics of the present invention, as the wear-resisting element is attached to the press section, and the wear-resisting element has physical properties of being high in hardness and tolerable to large temperature differences, the wear-resisting element is durable for prolonged use to improve the drawback of being wear-prone of a conventional mouse.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a mouse structure of the present invention.

FIG. 2 is a sectional view of a mouse structure of the present invention.

### DETAILED DESCRIPTION OF THE PREFERRED EMBODIMENTS

The present invention is directed to a mouse button structure. Details of the present invention are described below with reference to the accompanying drawings.

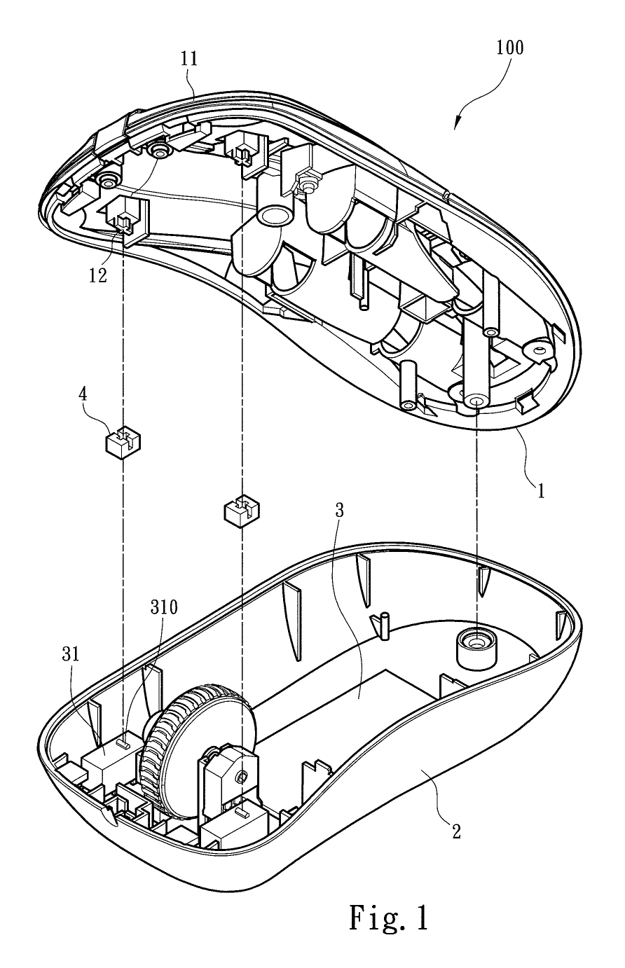

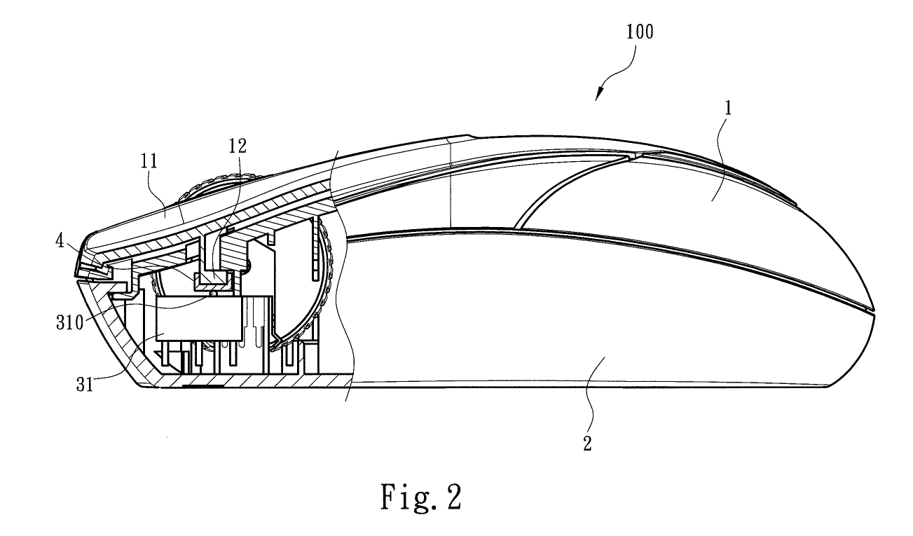

Referring to FIGS. 1, and 2 respectively showing an exploded view and a sectional view of a mouse structure 100 of the present invention, the mouse structure 100 includes an upper housing 1, a lower housing 2 and a circuit unit disposed between the upper housing 1 and the lower housing 2. The circuit unit includes a circuit board 3 and at least one press switch 31. The upper housing 1 includes at least one button unit, with the number of the press switch 31 corresponding to that of the button unit. The button unit includes a button cap section 11 revealed at a surface of the mouse 100, and a press section 12 connected with the button cap section 11 and extending towards the press switch 31. The button cap section 11 is revealed at the surface of the house 100 to be pressed by a user. When the button cap section 11 is pressed, the button cap section 11 is jointly moved with the press section 12. The button unit further includes a wear-resisting element 4. The wear-resisting element 4 is attached to one end of the press section 12 facing the press switch 31, in a way that the wear-resisting element 4 is located between the press section 12 and the press switch 31. The press switch 31 includes a triggering section 310. When being pressed, the triggering section 310 withdraws to trigger a conductive element in the press switch 31 to generate a press signal, which is then transmitted to the circuit board, converted, and outputted. Since the wear-resisting element 4 is attached to one side of the press section 12, as the button cap section 11 propels and moves the press section 12, the wear-resisting element 4 abuts against the triggering section 310 of the press switch 31 to prompt the press switch 31 to generate the press signal. For example, the wear-resisting element 4 is a metal block. More specifically, the wear-resisting element 4 may be a group selected from a copper compound, an aluminum compound or an iron compound. Alternatively, the wear-resisting element 4 may be a non-metal block, such as a group selected from carbon fiber, ceramic or a high polymer material. For example, the high polymer material may be polyoxymethylene (POM), i.e., so-called plastic steel. In contribution to satisfactory physical properties of the wear-resisting element 4, a wear level of the wear-resisting element 4 is far less than that of a conventional mouse under prolonged use and frequent impacts of the wear-resisting element 4 and the triggering section 310. Further, under extraordinary circumstances of high and low temperatures, the wear-resisting characteristic of the wear-resisting element 4 can still be maintained to ensure that the mouse 100 has a longer life cycle. A surface of the wear-resisting element 4 coming into impact with triggering section 310 may be a flat surface or an arched surface.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A button structure of a mouse, the mouse comprising a lower housing, an upper housing, and a circuit unit disposed between the upper housing and the lower housing, the circuit unit comprising at least one press switch, the upper housing comprising at least one button unit, characterized in that:
the at least one button unit comprises a revealed button cap section, a press section connected to the button cap section and extending towards the press switch, and a wear-resisting element attached to the press section;
wherein, when the button cap section is pressed to move downwards jointly with the press section, the wear-resisting element abuts against the at least one press switch.

2. The button structure of claim 1, wherein the wear-resisting element is a metal block.

3. The button structure of claim 2, wherein the metal block is selected from a group consisting of a copper compound, an aluminum compound, and an iron compound.

4. The button structure of claim 1, wherein the wear-resisting element is a non-metal block.

5. The button structure of claim 4, wherein the non-metal block is selected from a group consisting of a high polymer material, ceramic and carbon fiber.

6. The button structure of claim 5, wherein the high polymer material is polyoxymethylene (POM).

7. The button structure of claim 1, wherein the circuit unit comprises a circuit board, and the at least one press switch is electrically connected to the circuit board.
